(19) United States
(12) Patent Application Publication
(10) Pub. No.: US 2024/0367024 A1
(43) Pub. Date: Nov. 7, 2024

(54) TOOL FOR EVALUATING FOOTBALL SPECIALISTS

(71) Applicant: Christopher Adam Husby, Maple Grove, MN (US)

(72) Inventor: Christopher Adam Husby, Maple Grove, MN (US)

(21) Appl. No.: 18/656,281

(22) Filed: May 6, 2024

Related U.S. Application Data
(60) Provisional application No. 63/500,022, filed on May 4, 2023.

(51) Int. Cl. A63B 71/06; A63B 24/00

(52) U.S. Cl. CPC A63B 71/0616; A63B 24/0062; A63B 2220/05; A63B 2220/806; A63B 2243/007

(57) ABSTRACT

This disclosure includes methods for evaluating talent of football specialists. A device receives one or more sets of play data for a football specialist, each set of play data comprising data descriptive of one or more of a process and an outcome of a football action performed by the football specialist. The device applies an evaluative model to the one or more sets of play data for the football specialist. The device outputs, based on the application of the evaluative model, one or more evaluations for the football specialist, each evaluation indicating a skill level of a respective attribute for the football specialist.

### RELATED APPLICATIONS

This application claims the benefit of U.S. Provisional Patent Application No. 63/500,022, filed May 4, 2023, the entire contents of which are incorporated herein by reference.

### TECHNICAL FIELD

The disclosure relates to evaluation tools for football players.

### BACKGROUND OF THE INVENTION

Talent evaluation in American football has turned into a booming and competitive industry. As football teams at all levels of amateurism and professionalism have begun to profit more and more, it is becoming even more important to bring in the highest level of talent onto a team, as winning teams make more money than losing teams. Many top offensive and defensive players will consistently attend camps and push highlight videos to coaches who use their experience and skills to evaluate those players.

One area that has fallen behind is evaluating specialists, such as kickers, punters, and long snappers. Given the limited playing time these players see in a typical game, many coaches fail to provide an adequate amount of time to scouting these players. Additionally, kicking is largely a results- and data-driven area of the game, but much of this information is hard to discern in low-tech videos, such as those available for high school sports or low-level college games, if those videos are available at all. Furthermore, each job for a specialist is largely able to be evaluated on an individual basis, with teammates having limited influence on the result of a play unless the play results in a blocked kick. Despite the limited playing time, specialists still have a large impact on the results of a game, and recruiting talented players for those positions is important.

### SUMMARY OF THE INVENTION

In general, the disclosure is directed to a method for applying a quantitative analysis to a skill level of a football specialist. A computing device receives data descriptive of a play, whether it be a play from a practice or a play from a game. The computing device tabulates enough of this data and applies an evaluative model to the data. The computing device takes the results of this model application and generates one or more scores for the specialist, indicating either an overall skill level of the specialist or a number of skill levels for different attributes of the specialist (e.g., power, accuracy, consistency, etc.). Based on the quantitative score, qualitative determinations could be made, such as by indicating what level of football that specialist could succeed in given their skill level (e.g., professional, division one college football, division two college football, etc.).

In one example, this disclosure is directed to a method including receiving, by one or more processors, one or more sets of play data for a football specialist, each set of play data comprising data descriptive of one or more of a process and an outcome of a football action performed by the football specialist. The method further includes applying, by the one or more processors, an evaluative model to the one or more sets of play data for the football specialist. The method also includes outputting, by the one or more processors and based on the application of the evaluative model, one or more evaluations for the football specialist, each evaluation indicating a skill level of a respective attribute for the football specialist.

In another example, the disclosure is directed to a non-transitory computer-readable storage medium having stored thereon instructions that, when executed, cause one or more processors of a computing device to receive one or more sets of play data for a football specialist, each set of play data comprising data descriptive of one or more of a process and an outcome of a football action performed by the football specialist. The instructions, when executed, further cause the one or more processors to apply an evaluative model to the one or more sets of play data for the football specialist. The instructions, when executed, also cause the one or more processors to output, based on the application of the evaluative model, one or more evaluations for the football specialist, each evaluation indicating a skill level of a respective attribute for the football specialist.

In another example, the disclosure is directed to a system that includes one or more sensors configured to collect one or more sets of play data for a football specialist, each set of play data comprising data descriptive of one or more of a process and an outcome of a football action performed by the football specialist. The system further includes one or more processors configured to receive the one or more sets of play data, apply an evaluative model to the one or more sets of play data for the football specialist, and output, based on the application of the evaluative model, one or more evaluations for the football specialist, each evaluation indicating a skill level of a respective attribute for the football specialist.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a football specialist performing a play and a computing device configured to evaluate the football specialist's performance in the play, in accordance with the techniques described herein.

FIG. 2 is a block diagram illustrating a more detailed example of a computing device configured to perform the techniques described herein.

FIG. 3 is a flow diagram illustrating an example process of evaluating a football specialist, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

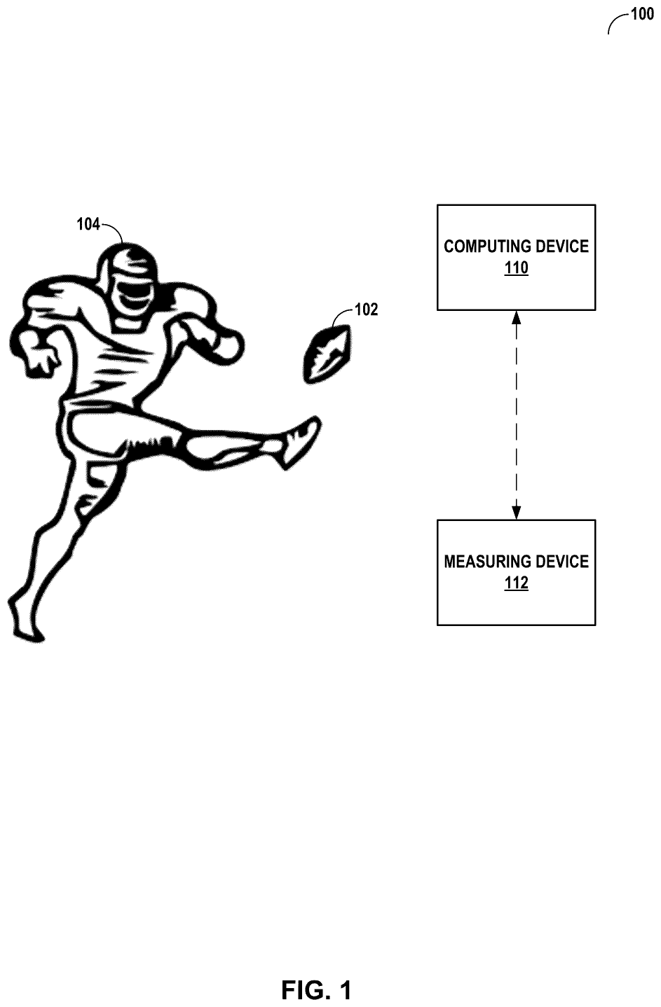

FIG. 1 is a conceptual diagram illustrating a football specialist 104 performing a play and a computing device 110 configured to evaluate the football specialist 104's performance in the play, in accordance with the techniques described herein. In environment 100, football specialist 104 is kicking football 102. Environment 100 could be one or more of a sanctioned football game, a scrimmage, a practice, a camp, a training session, or any other environment where a football player would be kicking a football in a manner similar to that of a football play.

Specialist 104 may be kicking football 102 as part of a kickoff, a field goal, or a punt. The result of the play of specialist 104 kicking football 102 will be recorded as play data, potentially including elements such as a distance measurement of the kick, a height of the kick, a success of the kick, and an accuracy of the kick, among other things. These results could be logged by hand or with measuring device 112, such as through the use of cameras installed among environment 100 or sensors located in football 102 in combination with sensor readers installed throughout environment 100.

These results are sent to computing device 110, either through manual entry or by wireless or wired communication between measuring device 112 (e.g., the cameras or the sensors/sensor readers), where further analysis is performed. Computing device 110 applies an evaluative model to the one or more sets of play data for football specialist 104 and outputs, based on the application of the evaluative model, one or more evaluations for football specialist 104, each evaluation indicating a skill level of a respective attribute for football specialist 104.

When measuring device 112 includes sensors, the sensors in football 102 and/or the sensor readers in environment 100 can measure data points such as ball location, spin rate, ball apex during flight, velocity, hangtime, foot to ball contact angle or foot contact angle, and any other physical characteristics about the flight and travel of football 102 during the play. Computing device 110 may control these sensors to measure such data. The various sensors 102 or measuring devices 112 may be made up of any one or more of a camera, a motion sensor, an accelerometer, a gyroscope, a magnetic sensor, a photoelectric sensor, a radar sensor, a lidar sensor, and a proximity sensor.

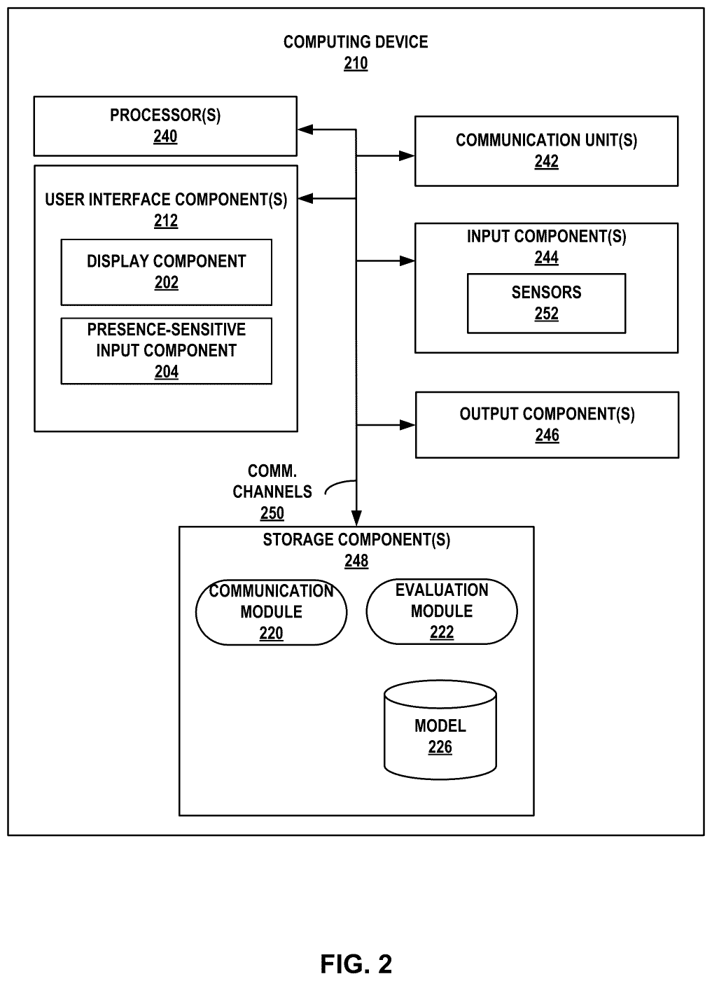

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, evaluation module 222, and model 226.

One or more processors 240 may implement functionality and/or execute instructions associated with computing device 210 to evaluate a football specialist. That is, processors 240 may implement functionality and/or execute instructions associated with computing device 210 to receive play data for a football specialist and perform an evaluation on the football specialist.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to communicate with input devices and evaluate football specialists.

Communication module 220 may execute locally (e.g., at processors 240) to provide functions associated with communicating with input devices (e.g., a client device, a camera, or a sensor) to receive play data for a football specialist. In some examples, communication module 220 may act as an interface to a remote service accessible to computing device 210. For example, communication module 220 may be an interface or application programming interface (API) to a remote server that handles the transfer of play data from the input device to computing device 210.

In some examples, evaluation module 222 may execute locally (e.g., at processors 240) to provide functions associated with evaluating the football specialists. In some examples, evaluation module 222 may act as an interface to a remote service accessible to computing device 210. For example, evaluation module 222 may be an interface or application programming interface (API) to a remote server that handles the received play data and evaluates the play data using model 226.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and model 226. Storage components 248 may include a memory configured to store data or other information associated with modules 220 and 222 and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, communication module 220 may receive one or more sets of play data for a football specialist, each set of play data including data descriptive of one or more of a process and an outcome of a football action performed by the football specialist. For instance, the play data could include data descriptive of the football during the play, such as a ball speed or a hangtime, or a final result of the kick, such as a ball landing location or a success/failure indication of a field goal or extra point kick.

Communication module 220 may control one or more sensors to capture the sets of play data. In some instances, the one or more sensors may be one or more cameras, where communication module controls the one or more cameras to capture respective video streams. In receiving the one or more sets of play data, communication module 220 may collect the video streams from the one or more cameras installed at a playing field. Evaluation module 222 may then evaluate each video stream to derive a respective set of play data for a given play, such as where the kick started, where the kick ended, whether the kick was successful, a velocity of the ball given known distances and times, hangtimes of the ball given known times from the start of the kick to the end of the kick, and any other piece of data described herein that could be derived from video data using computer vision techniques.

In some other instances, in receiving the one or more sets of play data, communication module 220 may control one or more sensors to collect each set of play data while the play is occurring, the one or more sensors being installed in one or more of a football used in the play, a field on which the play occurs, pylons used to mark the field, and goalposts installed on the field. The one or more sensors may be any one or more of a camera, a motion sensor, an accelerometer, a gyroscope, a magnetic sensor, a photoelectric sensor, a radar sensor, a lidar sensor, and a proximity sensor.

For instance, when the sensor is a motion sensor, the sensor may detect the presence of a football in an expected location, such as between uprights of a goalpost or in an area of the kicker or punter. Motion sensors may trigger when snaps occur and plays begin or when kicks are attempted or made.

For instance, when the sensor is an accelerometer, the sensor may be installed within the football to determine a speed, velocity, and acceleration of the football during a kick or punt.

For instance, when the sensor is a gyroscope, the sensor may be installed within the football and may measure various rotations, orientations, or spirals of the football in the air.

For instance, when the sensor is a magnetic sensor, a magnetically detectable material may be placed within the football, and a sensor installed in the goalpost or in some other location on or near the field may detect when the football comes near the sensor, such as through the goalposts or near a particular location on the field.

For instance, when the sensor is a photoelectric sensor, the sensors may be installed in the goalposts or near particular locations on the field. The photoelectric sensor may output light via a light transmitter that is received and measured by a photoelectric received. In the instance of the goalposts, when a football travels through the uprights, indicating a successful kick, the sensor may detect the object passing through the uprights and indicate a successful kick.

For instance, when the sensor is a radar sensor, the sensors may be installed in or on the field of play, or on equipment in or on the field of play, to determine the position of the football throughout the play.

For instance, when the sensor is a lidar sensor, the sensors may be installed in or on the field of play, or on equipment in or on the field of play, to determine the position of the football throughout the play.

For instance, when the sensor is a proximity sensor, the sensors may be installed in or on the field of play, or on equipment in or on the field of play, to determine when the football is nearby a particular sensor. When the sensors are mapped to the field of play, location of the football throughout the play can be tracked.

In still some other instances, in receiving the one or more sets of play data, communication module 220 may receive indications of user input entering the data contained in each set of play data.

Evaluation module 222 may apply evaluative model 226 to the one or more sets of play data for the football specialist. In some instances, evaluation module 222 may further train evaluative model 226 based on actual game data for each of a plurality of levels of football (e.g., high school football, collegiate football, professional football, etc.).

In applying evaluative model 226, evaluation module 222 may utilize any number of methods. For instance, evaluation module 222 may employ computer vision techniques to analyze one or more video streams to generate the various sets of play data. In other instances, evaluation module 222 may receive the data itself from various sensors or inputs. With the data, evaluation module 222 may compare the data to various thresholds of statistics indicative of specialist success at various levels of football. Using certain weights and algorithms in evaluative model 226, evaluation module 222 may generate a score or set of scores to ultimately evaluate the player.

Evaluation module 222 may output, based on the application of the evaluative model, one or more evaluations for the football specialist, each evaluation indicating a skill level of a respective attribute for the football specialist. For instance, each of the one or more evaluations indicates a percentage likelihood of success the football specialist would have at a particular level of football given the respective skill level of the respective attribute. In other instances, each of the one or more evaluations indicates a particular level of football that the football specialist would succeed in given the respective skill level of the respective attribute based on the respective skill level meeting a threshold associated with that particular level of football. For the purposes of this disclosure, the particular level of football could include any one or more of high school football, division three college football, division two college football, division one football championship subdivision college football (e.g., high-level division one football), division one football bowl subdivision group of five conferences college football (e.g., high-level division one football), division one football bowl subdivision power five conferences college football, international professional football, low-level American professional football, and high-level American professional football. In other instances, the skill level may be an indication as to whether the kicker is improving, such as “still developing,” “developing with minor adjustments,” “almost refined,” and “fully refined.”

In some instances, the football specialist may be a kicker. For kickoff plays, each set of play data may include one or more of kickoff distance, distance deviation from a middle of a football field, a touchback indication, a kick hangtime, a ball flight speed, a ball contact angle, a field location of the kick, and a landed ball field location. For field goal or extra point plays, each set of play data may include any one or more of a distance of kick, one of a make indication or a miss indication, a distance deviation from a center of a goal post opening, an indication of whether the ball was held on a block or directly on a field, a field location of the kick, a kick apex, and a ball height at a line of scrimmage.

In some other instances, the football specialist may be a punter. In such instances, each set of play data may include any one or more of a punt distance, a deviation from an intended location, a hangtime, a punt apex, a touchback indication, a time from a snap to a kick. a landed ball field location, a field location of the punt, a ball flight speed, a ball contact angle, a spin direction, and a rotation speed.

In still some other instances, the football specialist may be a long snapper. In such instances, and each set of play data may include any one or more of a snap accuracy, a snap precision, a ball speed, a time from a snap to a ball making contact with an intended target, a time from the snap to taking a blocking stance, a spiral tightness, a location of laces of the ball after being caught by the intended target, a 40-yard dash time, an agility measurement, a body height, a body weight, a bench press maximum, and a squat maximum.

In some instances, evaluation module 222 may further calculate statistical data based on the one or more sets of play data. For instance, evaluation module 222 may calculate one or more of an average, a variance, or a percentage of any type of data point in the one or more sets of play data for the kickers, punters, or long snappers.

In some instances, evaluation module 222 may rank specialists. For instance, the football specialist may be a first football specialist in a plurality of football specialists. Evaluation module 222 may rank the plurality of football specialists based on the one or more evaluations for each respective football specialist, including one or more of overall evaluation rankings and attribute-by-attribute evaluation rankings.

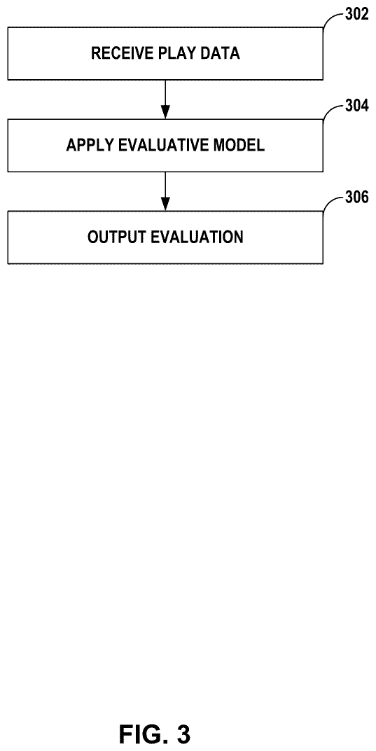

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques described herein, communication module 220 may receive one or more sets of play data for a football specialist (302), each set of play data comprising data descriptive of one or more of a process and an outcome of a football action performed by the football specialist. Evaluation module 222 may apply an evaluative model 226 to the one or more sets of play data for the football specialist (304). Evaluation module 222 may output, based on the application of the evaluative model 226, one or more evaluations for the football specialist (306), each evaluation indicating a skill level of a respective attribute for the football specialist.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
receiving, by one or more processors, one or more sets of play data for a football specialist, each set of play data comprising data descriptive of one or more of a process and an outcome of a football action performed by the football specialist;
applying, by the one or more processors, an evaluative model to the one or more sets of play data for the football specialist; and
outputting, by the one or more processors and based on the application of the evaluative model, one or more evaluations for the football specialist, each evaluation indicating a skill level of a respective attribute for the football specialist.

2. The method of claim 1, wherein the football specialist comprises a kicker.

3. The method of claim 2, wherein each set of play data comprises one or more of:
kickoff distance;
distance deviation from a middle of a football field;
a touchback indication;
a kick hangtime;
a ball flight speed;
a ball contact angle;
a field location of the kick;
a clean maximum weight;
a broad jump length;
a kicker height;
a kicker weight;
a kicker grade point average; and
a landed ball field location.

4. The method of claim 2, wherein each set of play data comprises one or more of:
distance of kick;
one of a make indication or a miss indication;
a distance deviation from a center of a goal post opening;
an indication of whether the ball was held on a block or directly on a field;
a field location of the kick;
a kick apex;
a clean maximum weight;
a broad jump length;
a kicker height;
a kicker weight;
a kicker grade point average; and
a ball height at a line of scrimmage.

5. The method of claim 1, wherein the football specialist comprises a punter, and wherein each set of play data comprises one or more of:
a punt distance;
a deviation from an intended location;
a hangtime;
a punt apex;
a touchback indication;
a time from a snap to a kick;
a landed ball field location;
a field location of the punt;
a ball flight speed;
a ball contact angle;
a spin direction;
a clean maximum weight;
a broad jump length;
a punter height;
a punter weight;
a punter grade point average; and
a rotation speed.

6. The method of claim 1, wherein the football specialist comprises a long snapper, and wherein each set of play data comprises one or more of:
a snap accuracy;
a snap precision;
a ball speed;
a time from a snap to a ball making contact with an intended target;
a time from the snap to taking a blocking stance;
a spiral tightness;
a location of laces of the ball after being caught by the intended target;
a 40-yard dash time;
an agility measurement;
a body height;
a body weight;
a bench press maximum;
a clean maximum weight;
a broad jump length;
a long snapper grade point average; and
a squat maximum.

7. The method of claim 1, further comprising:
calculating, by the one or more processors, statistical data based on the one or more sets of play data, wherein the statistical data comprises one or more of an average, a variance, or a percentage of any type of data point in the one or more sets of play data.

8. The method of claim 1, wherein each of the one or more evaluations indicates a percentage likelihood of success the football specialist would have at a particular level of football given the respective skill level of the respective attribute.

9. The method of claim 8, wherein the particular level of football comprises one of:
high school;
division three;
division two;
division one football championship subdivision;
high-level division one football;
low-level division one football;
international professional;
low-level American professional; and
high-level American professional.

10. The method of claim 1, wherein each of the one or more evaluations indicates a particular level of football that the football specialist would succeed in given the respective skill level of the respective attribute based on the respective skill level meeting a threshold associated with that particular level of football.

11. The method of claim 1, wherein receiving the one or more sets of play data comprises:
controlling, by the one or more processors, one or more cameras installed at a playing field to capture one or more video streams of a given play; and
evaluating, by the one or more processors, each video stream to derive a respective set of play data for the given play.

12. The method of claim 1, wherein receiving the one or more sets of play data comprises:
controlling, by the one or more processors, one or more sensors to collect each set of play data while the play is occurring, the one or more sensors being installed in one or more of a football used in the play, a field on which the play occurs, pylons used to mark the field, and goalposts installed on the field.

13. The method of claim 1, wherein receiving the one or more sets of play data comprises:
receiving, by the one or more processors, indications of user input entering the data contained in each set of play data.

14. The method of claim 1, wherein the football specialist comprises a first football specialist in a plurality of football specialists, and wherein the method further comprises:
ranking, by the one or more processors, the plurality of football specialists based on the one or more evaluations for each respective football specialist.

15. The method of claim 1, further comprising:
training, by the one or more processors, the evaluative model based on actual game data for each of a plurality of levels of football.

16. A non-transitory computer-readable storage medium having stored thereon instructions that, when executed, cause one or more processors of a computing device to:
receive one or more sets of play data for a football specialist, each set of play data comprising data descriptive of one or more of a process and an outcome of a football action performed by the football specialist;
apply an evaluative model to the one or more sets of play data for the football specialist; and
output, based on the application of the evaluative model, one or more evaluations for the football specialist, each evaluation indicating a skill level of a respective attribute for the football specialist.

17. A system comprising:
one or more sensors configured to collect one or more sets of play data for a football specialist, each set of play data comprising data descriptive of one or more of a process and an outcome of a football action performed by the football specialist; and
one or more processors configured to:
receive the one or more sets of play data;
apply an evaluative model to the one or more sets of play data for the football specialist; and
output, based on the application of the evaluative model, one or more evaluations for the football specialist, each evaluation indicating a skill level of a respective attribute for the football specialist.

18. The system of claim 17, wherein the one or more sensors comprise one or more of:
a camera,
a motion sensor,
an accelerometer,
a gyroscope,
a magnetic sensor,
a photoelectric sensor,
a radar sensor,
a lidar sensor, and
a proximity sensor.

19. The system of claim 17, wherein the one or more sensors are installed in one or more of:
a football used in the play,
a field on which the play occurs,
one or more pylons used to mark the field, and
one or more goalposts installed on the field.

20. The system of claim 17, wherein the one or more processors being configured to receive the one or more sets of play data comprise the one or more processors being configured to:
control the one or more sensors, comprising one or more cameras installed at a playing field, to capture one or more video streams of a given play;
receive the one or more video streams from the one or more cameras, and
evaluate each video stream to derive a respective set of play data for the given play.
